(19) United States
(12) Patent Application Publication
(10) Pub. No.: US 2026/0042710 A1
(43) Pub. Date: Feb. 12, 2026

(54) METHOD FOR PRODUCING ZIRCONIA POWDER CONTAINING MULTIPLE RARE EARTH ELEMENTS

(71) Applicant: National Chung Shan Institute of Science and Technology, Taoyuan (TW)

(72) Inventors: Wei-Ting Hsu, Taoyuan (TW); Yen-Chung Chen, Taoyuan (TW)

(21) Appl. No.: 18/800,033

(22) Filed: Aug. 10, 2024

(51) Int. Cl. C04B 35/626; C04B 35/48; C04B 35/624; C04B 41/00

(52) U.S. Cl. CPC C04B 35/62635; C04B 35/48; C04B 35/624; C04B 35/6264; C04B 35/62675; C04B 35/6268; C04B 41/0045; C04B 2235/3224; C04B 2235/3244

(57) ABSTRACT

is disclosed. The method includes the following steps: (A) Dissolving a zirconium compound in an inorganic acid and adding a rare earth oxide to form a first mixture solution; (B) Creating a yttrium solution in an organic solvent or deionized water, then adding it to the first mixture solution with a dispersant and chelating agent, and performing ultrasonic vibration to form a second mixture solution; (C) Heating and stirring the second mixture solution to form a sol-gel mixture; (D) Performing thermal decomposition on the sol-gel mixture to create a zirconia precursor; (E) Performing heat treatment on the zirconia precursor to obtain the final zirconia powder.

### BACKGROUND

### Technical Field

The disclosure relates to a method for producing zirconia powder. More particularly, the disclosure relates to a method for producing zirconia powder containing multiple rare earth elements.

### Description of Related Art

Yttrium-containing zirconia powder with added rare earth elements is one of the most important thermal barrier coating materials for aerospace components. In gas turbine applications, it not only provides corrosion resistance and increases operating temperature but also reduces fuel consumption and extends engine life. Thermal barrier coating materials generally require properties such as high melting point, no phase transition within the operating temperature range, low thermal conductivity, corrosion resistance, strong adhesion to the substrate material, matching thermal expansion coefficients, low sintering rate, suitable mechanical properties, and other special requirements. Materials that meet the above conditions are very limited in the entire material range and can be improved by adding rare earth elements in different proportions to enhance compatibility in various environments.

The prior art methods for producing yttrium-containing zirconia powder with added rare earth elements include co-precipitation, hydrothermal synthesis, hydrolysis, solid-state diffusion, chemical vapor deposition (CVD), sol-gel, pyrolysis reduction, etc. However, the aforementioned technologies face challenges in achieving low raw material costs, a stable and fast process, and the production of uniformly high-purity yttrium-containing zirconia powder with added rare earth elements. Additionally, they struggle with issues related to uneven and excessively large particle sizes. Therefore, producing high-purity yttrium-containing zirconia powder with submicron dimensions is an urgent problem in the industry.

In summary, current methods for producing yttrium-containing zirconia powder with added rare earth elements have defects. Thus, the applicant has developed a method for producing zirconia powder containing multiple rare earth elements, which shortens the reaction time and improves reaction uniformity

### SUMMARY

In view of the above-mentioned drawbacks of the prior art, an aspect of the invention is to produce zirconia powder containing multiple rare earth elements using microwave synthesis, which shortens the decomposition reaction time and improves decomposition reaction uniformity.

Another aspect is to propose a chemical synthesis method for producing zirconia powder containing multiple rare earth elements, offering rapid thermal decomposition and heat treatment reactions. This chemical synthesis method increases the reaction quantities of zirconium and yttrium sources and rare earth elements, achieving a near atomic ratio of 8:1 for yttrium-containing zirconia powder with added rare earth elements.

To achieve the above aspects, the invention provides a method for producing zirconia powder containing multiple rare earth elements, comprising the following steps: (A) Dissolving a zirconium compound in an inorganic acid to form a solution, then adding a rare earth oxide and stirring to obtain a first mixture solution; (B) Dissolving an yttrium compound in an organic solvent or deionized water to form a yttrium solution, adding the yttrium solution to the first mixture solution along with a dispersant and a chelating agent, and performing ultrasonic vibration to optimally disperse the zirconium compound, the rare earth oxide, the yttrium compound in the solution of the inorganic acid to form a second mixture solution; (C) Heating and stirring the second mixture solution to form a sol-gel mixture; (D) Performing a thermal decomposition on the sol-gel mixture to form a zirconia precursor; and (E) Performing a heat treatment on the zirconia precursor to obtain zirconia powder containing multiple rare earth elements.

According to an embodiment of this invention, the zirconium compound is selected from zirconium carbonate, zirconium oxalate, zirconium phosphate, and zirconium citrate, or a combination thereof.

According to another embodiment of this invention, the rare earth oxide is selected from yttrium oxide, lanthanum oxide, cerium oxide, neodymium oxide, samarium oxide, gadolinium oxide and erbium oxide, or a combination thereof.

According to yet another embodiment of this invention, the weight percentage of the rare earth oxide is 2%-10%.

According to yet another embodiment of this invention, the inorganic acid is selected from sulfuric acid, hydrochloric acid, acetic acid, citric acid, and nitric acid, or a combination thereof.

According to yet another embodiment of this invention, the organic solvent is selected from methanol, methanol-water solution, ethanol, ethanol-water solution, formic acid, formic acid-water solution, acetic acid, and acetic acid-water solution, or a combination thereof.

According to yet another embodiment of this invention, the yttrium compound is selected from anhydrous yttrium nitrate, yttrium nitrate tetrahydrate, yttrium nitrate hexahydrate, anhydrous yttrium acetate, and yttrium acetate tetrahydrate, or a combination thereof.

According to yet another embodiment of this invention, the weight percentage of the yttrium compound is 5%-40%.

According to yet another embodiment of this invention, the chelating agent is selected from ethylenediamine, o-phenanthroline, sodium oxalate, ethylenediaminetetraacetic acid, and dimethylglyoxime, or a combination thereof.

According to yet another embodiment of this invention, the thermal decomposition is performed by microwave irradiation with microwave power greater than 600 W on the sol-gel mixture at two different temperatures, the first stage temperature is set to 250-400° C. for 10-30 minutes, and the second stage temperature is set to 400-600° C. for 20-40 minutes.

According to yet another embodiment of this invention, the heat treatment is performed by calcination in an atmosphere with a mixture of nitrogen and oxygen gases at a temperature of 1100° C.-1500° C. for at least 1-5 hours.

According to yet another embodiment of this invention, the heat treatment process is performed by high-frequency calcination with a mixture of nitrogen and oxygen gases at a temperature of 1100-1500° C. for at least 1-5 hours.

According to yet another embodiment of this invention, the heat treatment process is performed by microwave irradiation in an atmosphere with a mixture of nitrogen and oxygen gases, with microwave power of 1300-2000 W, at a temperature of 1100° C.-1500° C. for at least 1-5 hours.

The above summary, along with the following detailed description and accompanying drawings, aims to further illustrate the methods, techniques, and effects employed to achieve the intended objectives of this invention. Additional objectives and advantages of the invention will be explained in the subsequent descriptions and figures.

### BRIEF DESCRIPTION OF THE DRAWINGS

FIG. 1 is a flowchart illustrating a method for producing zirconia powder containing multiple rare earth elements according to an embodiment of this invention.

FIG. 2 is a schematic diagram of the SEM (Scanning Electron Microscope) image of the zirconia powder containing multiple rare earth elements produced according to an embodiment of this invention.

### DETAILED DESCRIPTION

The following provides specific examples to illustrate the implementation of this invention. Those skilled in the art can easily understand the advantages and effects of this invention based on the content disclosed in this description.

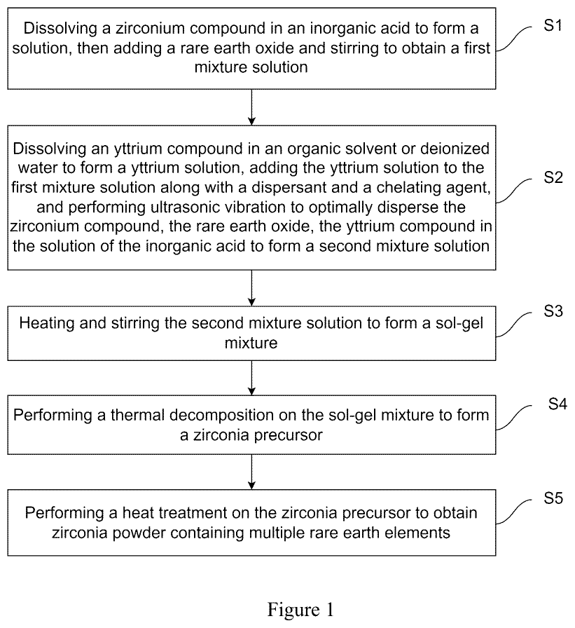

Please refer to FIG. 1, which is a flowchart illustrating a method for producing zirconia powder containing multiple rare earth elements according to an embodiment of this invention.

In step S1, a zirconium compound is dissolved in an inorganic acid to form a solution, and a rare earth oxide is added to the solution and then stirred to obtain a first mixture solution. According to an embodiment of this invention, the zirconium compound is selected from zirconium carbonate, zirconium oxalate, zirconium phosphate, and zirconium citrate, or a combination thereof. According to another embodiment of this invention, the rare earth oxide is selected from yttrium oxide, lanthanum oxide, cerium oxide, neodymium oxide, samarium oxide, gadolinium oxide and erbium oxide, or a combination thereof. According to yet another embodiment of this invention, the inorganic acid is selected from sulfuric acid, hydrochloric acid, acetic acid, citric acid, and nitric acid, or a combination thereof.

In step S2, an yttrium compound is dissolved in an organic solvent or deionized water to form a yttrium solution. The yttrium solution is added into the first mixture solution along with a dispersant and a chelating agent. Ultrasonic vibration is preformed to optimally disperse the zirconium compound, the rare earth oxide, the yttrium compound in the solution of the inorganic acid to form a second mixture solution. According to yet another embodiment of this invention, the organic solvent is selected from methanol, methanol-water solution, ethanol, ethanol-water solution, formic acid, formic acid-water solution, acetic acid, and acetic acid-water solution, or a combination thereof. According to yet another embodiment of this invention, the yttrium compound is selected from anhydrous yttrium nitrate, yttrium nitrate tetrahydrate, yttrium nitrate hexahydrate, anhydrous yttrium acetate, and yttrium acetate tetrahydrate, or a combination thereof. According to yet another embodiment of this invention, the chelating agent is selected from ethylenediamine, o-phenanthroline, sodium oxalate, ethylenediaminetetraacetic acid, and dimethylglyoxime, or a combination thereof.

In some embodiments of this invention, the weight percentage of the rare earth oxide is 2%-10%, the weight percentage of the yttrium compound is 5%-40%, and the weight percentage of the chelating agent is 10%-30%.

In step S3, the second mixture solution is heated and stirred to form a sol-gel mixture.

In step S4, a thermal decomposition is performed on the sol-gel mixture to form a zirconia precursor. According to an embodiment of this invention, the thermal decomposition is performed by microwave irradiation with microwave power greater than 600 W on the sol-gel mixture at two different temperatures, the first stage temperature is set to 250-400° C. for 10-30 minutes, and the second stage temperature is set to 400-600° C. for 20-40 minutes.

In step S5, a heat treatment is performed on the zirconia precursor to obtain zirconia powder containing multiple rare earth elements. For different implementations, the heat treatment can be one of atmospheric calcination, high-frequency calcination, or mixed atmosphere microwave irradiation. This heat treatment process involves passing a nitrogen-oxygen mixed gas to calcine the rare earth element-containing zirconia precursor into a crystalline phase. The mixed gas comprises nitrogen and oxygen, with an oxygen concentration of 20%-50% and a nitrogen concentration of 50%-80%. The heat treatment temperature is at a range of 1100 ° C.-1500 ° C., with a processing time of at least 1-5 hours.

According to yet another embodiment of this invention, the heat treatment is performed by calcination in an atmosphere with a mixture of nitrogen and oxygen gases at a temperature of 1100° C.-1500° C. for at least 1-5 hours.

According to yet another embodiment of this invention, the heat treatment process is performed by high-frequency calcination with a mixture of nitrogen and oxygen gases at a temperature of 1100-1500° C. for at least 1-5 hours.

According to yet another embodiment of this invention, the heat treatment process is performed by microwave irradiation in an atmosphere with a mixture of nitrogen and oxygen gases, with microwave power of 1300-2000 W, at a temperature of 1100° C.-1500° C. for at least 1-5 hours.

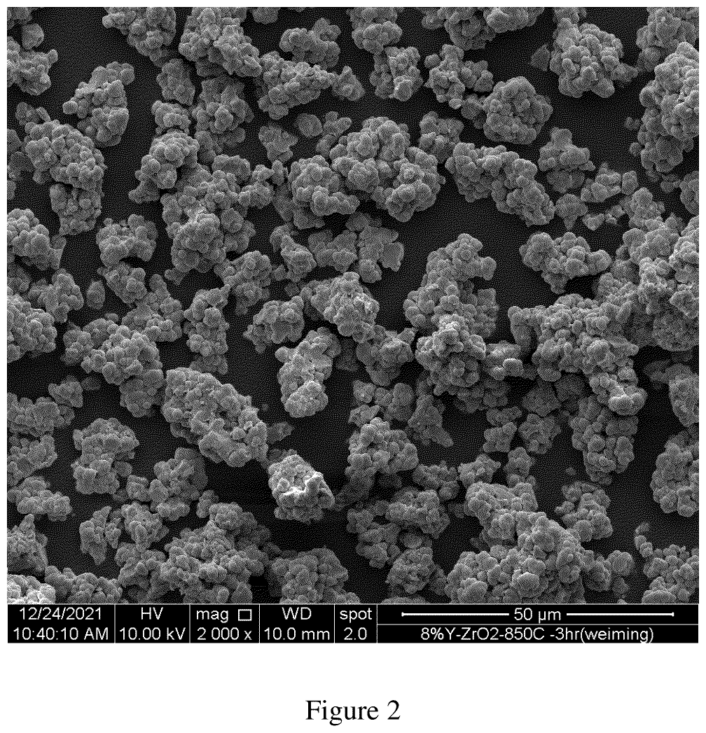

Through the method steps of this invention, zirconia powder with a purity exceeding 95% and a D50 particle size of ≤1 μm can be produced, as shown in FIG. 2.

In light of foregoing, embodiments of his invention utilize microwave synthesis, where the polar molecules in the solution are influenced by the electric field of the microwaves, causing them to rotate. This rotation generates substantial frictional heat, leading to a temperature rise. This effect is particularly significant for water molecules, whose rotational energy level is precisely at 2.45 GHz, resulting in nearly 100% energy absorption efficiency. The rapid rotational frictional heating is why microwaves are also commonly used for heating food. Another heating mechanism involves charged ions in the solution, which migrate up and down with the amplitude of the electric field waves. This high-frequency migration also generates significant frictional heat, similar to the relationship between current and resistance, where resistance converts electrical energy into heat. This principle facilitates rapid heating.

What is claimed is:

1. A method for producing zirconia powder containing multiple rare earth elements, comprising the steps of:
(A) dissolving a zirconium compound in an inorganic acid to form a solution, then adding a rare earth oxide and stirring to obtain a first mixture solution;
(B) dissolving an yttrium compound in an organic solvent or deionized water to form a yttrium solution, adding the yttrium solution to the first mixture solution along with a dispersant and a chelating agent, and performing ultrasonic vibration to optimally disperse the zirconium compound, the rare earth oxide, the yttrium compound in the solution of the inorganic acid to form a second mixture solution;
(C) heating and stirring the second mixture solution to form a sol-gel mixture;
(D) performing a thermal decomposition on the sol-gel mixture to form a zirconia precursor; and
(E) performing a heat treatment on the zirconia precursor to obtain zirconia powder containing multiple rare earth elements.

2. The method of claim 1, wherein the zirconium compound is selected from zirconium carbonate, zirconium oxalate, zirconium phosphate, and zirconium citrate, or a combination thereof.

3. The method of claim 1, wherein the rare earth oxide is selected from yttrium oxide, lanthanum oxide, cerium oxide, neodymium oxide, samarium oxide, gadolinium oxide and erbium oxide, or a combination thereof.

4. The method of claim 1, wherein the weight percentage of the rare earth oxide is 2%-10%.

5. The method of claim 1, wherein the inorganic acid is selected from sulfuric acid, hydrochloric acid, acetic acid, citric acid, and nitric acid, or a combination thereof.

6. The method of claim 1, wherein the organic solvent is selected from methanol, methanol-water solution, ethanol, ethanol-water solution, formic acid, formic acid-water solution, acetic acid, and acetic acid-water solution, or a combination thereof.

7. The method of claim 1, wherein the yttrium compound is selected from anhydrous yttrium nitrate, yttrium nitrate tetrahydrate, yttrium nitrate hexahydrate, anhydrous yttrium acetate, and yttrium acetate tetrahydrate, or a combination thereof.

8. The method of claim 1, wherein the weight percentage of the yttrium compound is 5%-40%.

9. The method of claim 1, wherein the chelating agent is selected from ethylenediamine, o-phenanthroline, sodium oxalate, ethylenediaminetetraacetic acid, and dimethylglyoxime, or a combination thereof.

10. The method of claim 1, wherein the weight percentage of the chelating agent is 10%-30%.

11. The method of claim 1, wherein the thermal decomposition is performed by microwave irradiation with microwave power greater than 600 W on the sol-gel mixture at two different temperatures, the first stage temperature is set to 250-400° C. for 10-30 minutes, and the second stage temperature is set to 400-600° C. for 20-40 minutes.

12. The method of claim 1, wherein the heat treatment is performed by calcination in an atmosphere with a mixture of nitrogen and oxygen gases at a temperature of 1100° C.-1500° C. for at least 1-5 hours.

13. The method of claim 1, wherein the heat treatment process is performed by high-frequency calcination with a mixture of nitrogen and oxygen gases at a temperature of 1100-1500° C. for at least 1-5 hours.

14. The method of claim 1, wherein the heat treatment process is performed by microwave irradiation in an atmosphere with a mixture of nitrogen and oxygen gases, with microwave power of 1300-2000 W, at a temperature of 1100° C.-1500° C. for at least 1-5 hours.
